(19) United States
(12) Patent Application Publication
(10) Pub. No.: US 2008/0023889 A1
(43) Pub. Date: Jan. 31, 2008

(54) BRICK ADDITIVES COMPRISING COLORANTS AND METHOD

(76) Inventors: Michael C. Cheshire, Chicago, IL (US); Marc A. Herpfer, Kildeer, IL (US); G. Robert Goss, Kenosha, WI (US)

Correspondence Address: WILDMAN HARROLD ALLEN & DIXON LLP, 225 WEST WACKER DRIVE, SUITE 2800, CHICAGO, IL, 60606, US

(21) Appl. No.: 11/457,661

(22) Filed: Jul. 14, 2006

(51) Int. Cl. B28B 1/00

(52) U.S. Cl. 264/644

(57) ABSTRACT

A colorant is combined with a liquid and incorporated into a brick additive comprising an interconnected porosity. The colorant may comprise at least one of a dye and pigment comprising a metal cation and preferably penetrates the interconnected pores of the brick additive. Application of the colorant to the additive enables the additive to exhibit substantially the same color as a matrix material in finished bricks incorporating the additive. Ideally, the colorant is capable of withstanding temperatures up to about 1,350° C. without a substantial loss of color imparting properties. The additive may comprise at least one of a phyllosilicate clay mineral, a zeolite and a diatomaceous earth.

### FIELD OF THE INVENTION

This invention relates generally to the manufacture of fired clays, such as bricks, and more particularly to additives used during the processing thereof.

### BACKGROUND

Brick additives confer benefits to many aspects of the brick-making process. Brick additives, for example, can improve recovery rates, reduce ceramic weight and dimensional shrinkage and improve drying characteristics. Although additives provide these advantageous properties, in some cases, aesthetic issues limit the desirability of their use. For example, a red brick incorporating lightly colored additives exhibits spotting in various locations corresponding to the positioning of the additives. This issue is compounded by the nature of the brick making process, where extruded brick columns (“slugs”) are commonly cut into individual bricks in a so-called “velour-cut” and by wire cutting machines, thereby exposing the cross-sections of the additives.

There is a need for a colorant that can modify the coloring of the internal and external surfaces of brick additives and that can withstand high temperature firing without a substantial loss of its color imparting properties.

### SUMMARY OF THE INVENTION

The present invention relates to an improved method for applying colorants to brick additives used in connection with the manufacture of finished bricks.

The method comprises the steps of providing a matrix material for forming finished bricks, providing a brick additive for incorporation into the matrix material, combining a colorant with a liquid to form a liquid-based colorant, applying the liquid-based colorant to the brick additive, incorporating the brick additive into the matrix material and firing the matrix material into finished bricks. In one embodiment, the brick additive comprises a plurality of particles with a plurality of interconnected pores, wherein at least a portion of the liquid based colorant penetrates the interconnected pores during the applying step. In another embodiment, the brick additive comprises at least one of a phyllosilicate clay mineral, a zeolite and diatomaceous earth. The liquid may be any organic or inorganic liquid, including water. The brick additive may be incorporated into the matrix material after the liquid-based colorant is applied to the additive. After firing, the colorant preferably exhibits substantially the same color as the matrix material in the finished bricks.

The colorant may be at least one of a dye and a pigment comprising a metal cation. It is typically selected from at least one of metal salts, including iron nitrate, manganese sulfate, potassium permanganate, iron acetate, iron stearates, manganese acetate, metal oxides, including iron oxide, manganese oxide, pure metals, including iron, manganese, nanoparticles comprising metal cations and combinations thereof. Many of these colorants are capable of withstanding temperatures up to about 1,350° C. without a substantial loss of color imparting properties. The colorant is typically added to the brick additive in an amount between about 0.1 wt. % and 10.0 wt. %.

The particulars of applying the colorant may vary. In one embodiment, applying the colorant comprises spraying the liquid based colorant onto the plurality of particles. In another embodiment, the brick additive is tumbled during the applying step. Additionally, the brick additive may be heated after the applying step but before the firing step at temperatures between about 454° C. and 815° C.

### BRIEF DESCRIPTION OF THE DRAWINGS

FIG. 1A illustrates the unconsolidated granules of Example 1a) after firing in accordance with Example 2a);

FIG. 1B illustrates a brick cookie comprising the granules of FIG. 1A after firing in accordance with Example 2a);

FIG. 2A illustrates the unconsolidated granules of Example 1c) after treatment with iron sulfate and firing in accordance with Example 2b);

FIG. 2B illustrates a brick comprising the granules of FIG. 2A after firing in accordance with Example 2b); and

FIG. 3 is a schematic of the brick-making process showing application of the colorant of the present invention to a brick additive.

### DETAILED DESCRIPTION

The present invention relates to a colorant composition and method for coloring a brick additive. The colorant is not only capable of coloring the external surfaces of the brick additive, but may also penetrate the brick additive to impart color throughout. Since the colorant is used in connection with brick additives, the colorant is preferably able to withstand high temperatures on the order of up to about 2,500° F. (1,371° C.), without a substantial loss of its color imparting properties. In certain embodiments, the colorant can withstand temperatures between about 850° F. (454° C.) and about 2,100° F. (1,149° C.) and more particularly between about 1,500° F. (815° C.) and about 2,000° F. (1,093° C.).

The colorant may be a dye or pigment. Dyes are any soluble substance used to color materials. Pigments are dry coloring matter, usually an insoluble powder, to be mixed with water, oil, or another base. Suitable colorants include soluble dyes. Additionally or alternatively, pigments with diameters less than about 750.0 nanometers may be employed. The pigments are sized so that penetration into the internal portion of the brick additive is possible. Typically, the colorant comprises a metal cation, such as Fe, Mn, Cu, Co, Ti, Ag, etc. Examples of such colorants include inorganic metal salts, including iron sulfate, iron nitrate, manganese sulfate, potassium permanganate, etc., organic metal salts, including iron acetate, iron stearates, manganese acetate, etc., metal oxides, including iron oxide, manganese oxide, pure metals, including iron, manganese, etc., nanoparticles with metal cations, or any liquid form of the previously mentioned colorants. Additionally, these substances may be combined in various concentrations. For example, a synthetic mixed phase iron and manganese oxide (Fe,Mn)₂O₃ with an iron oxide content of Fe₂O₃ at a minimum of 80% and maximum of 88% can be employed.

Preferably, the colorant exhibits substantially the same color as the matrix material in the finished brick. Iron based salts, for example, impart a red/orange coloration, while manganese based salts provide a brown coloration to both internal and external surfaces of the brick additive. To determine whether the colorant exhibits substantially the same color as the matrix material in the finished brick, colorant is applied to a brick additive in accordance with Example 1(c). The color treated additive is then mixed with and incorporated into a brick matrix, followed by firing at 2,100° F. to make a brick cookie. If, upon visual inspection, the coloring of the additive appears to blend with the coloring of the brick cookie, for example as shown in FIG. 2B, this feature is satisfied. The intensity of the coloration is a function of how much metal is added to the clay granules.

To prepare the colorant, the above-described colorants are typically combined with a liquid. The soluble dye may be dissolved in a liquid solvent and the insoluble pigments may be dispersed in a liquid base. Water is typically employed as the liquid solvent or base. Other types of inorganic and organic liquids can, however, be employed. Organic solvents (like acetone, hexane, alcohol, etc.), ionic liquids (like imidazolium derivatives, pyridinium derivatives, etc.), acids (like sulfuric, acetic, hydrochloric acids, etc.), bases (like sodium hydroxide, potassium hydroxides, etc.), and reducing agents in liquids (like sodium thiosulfate) are suitable. The dye solution concentration can range anywhere from 0.01 wt % up to the saturation point of each soluble colorant; preferably, solution concentration will range from 3.0 wt. % up to the saturation point. The pigment suspension concentration can range from 0.01 wt. % up to 50.0 wt. %; preferably, the suspension concentration should range from 10.0 wt. % up to 30.0 wt. %.

Various types of brick additives may be used in connection with the colorants of the present invention. The term brick additive, as used herein, means any additive added to a brick matrix before firing. As previously mentioned, the brick additive comprises a plurality of particles exhibiting a certain level of porosity. Individual pore size be between about 0.0001 microns to about 10.0 microns in diameter and more particularly between about 0.50 microns and 4.0 microns. Pore size may display a heterogeneous distribution, ranging in size from micro-pores (about 0.0001 microns to 0.002 microns) to meso-pores (about 0.002 microns to 0.05 microns) up to macro-pores (about 0.05 microns to 10 microns). Total porosity and pore size distribution may be measured to standard posrsimetry methods, or total porosity may be measured by liquid intake of the brick additive granules. The pore sizes should be measured by either mercury (Hg) or nitrogen (N₂) pore size analyzers.

According to another embodiment, the total porosity of the brick additive may be about 10 percent or more typically between about 20 percent and about 50 percent. Total pore volume, which is the total amount of pore volume per gram of brick additive material may be between about 0.1 cubic centimeters per gram to about 1.0 cubic centimeters per gram.

In still other embodiments, 5.0% or more of the total porosity may include an interconnected internal porosity, typically between about 15.0% and about 45.0%. The term interconnected internal porosity refers to at least some degree of interconnectivtiy or a network of paths between the pores within individual particles (intra-particular porosity) and/or between brick additive particles lying close together in the brick matrix (inter-particular porosity).

According to other aspects, certain materials may be employed as the brick additive. In illustrative embodiments, these materials display a high level of porosity and interconnectivity. Some materials, such as glass, vitrified clay and crushed brick exhibit relatively low levels of porosity and interconnectivity. Other materials, such as expanded perlite and pumice exhibit a relatively high internal porosity, but a low level of corresponding interconnectivity between individual pores. Still other materials, like raw sodium bentonite, exhibit relatively high levels of interconnectivity with low porosity. In accordance with the above-referenced embodiment of the present invention, phyllosilicate clay minerals, diatomaceous earth and zeolites may all exhibit high porosity while still maintaining a potentially high degree of interconnectivity.

Thus, according to one embodiment of the present invention, the brick additive may comprise a phyllosilicate clay mineral. The crystal habit of these clays is often flat, platy or book-like and most members display good basal cleavage. Although members tend to be soft, they can be remarkably resilient. In addition, phyllosilicates are often the last to chemically breakdown in erosional and weathering processes, and thus constitute a significant amount of soils and fine grained sedimentary rocks. This group may also be generally tolerant of high pressures and temperatures.

Phyllosilicates include the smectite and hormite families. The smectite family of clay minerals includes, but is not limited to the montmorillonite, beidellite, nontronite, hectorite, and saponite species of clays, one or more of which may be present in varying amounts. Typically, smectite minerals occur as extremely small particles. The hormite family of clay minerals includes, but is not limited to the attapulgite, often called palygorskite, and sepiolite species of clays. Some hormite minerals can form large crystals, and are often found in lucustrian or marine sediment or sometimes in hydrothermal deposits and/or soils.

Certain other embodiments of the present invention, neither of the smectite genus nor of the homite variety, that may be employed in the brick additive include diatomaceous earth, zeolites, vermiculites, and illites. Diatomaceous earth is a geological deposit that may be made up of the fossilized skeletons and tests of siliceous marine and fresh water or other organisms, particular diatoms and other algae. These skeletons may comprise hydrated amorphous silica or opal. Zeolites are porous crystalline solids that may contain silicon, aluminum or oxygen in their framework. Many zeolites, such as clinoptilolite, chabazite, phillipsite and mordenite occur naturally as minerals, and may be extensively mined in many parts of the world. Although occurring naturally, numerous zeolites may also be used in their synthetic forms such as Zeolite A, X or Y. Illite has been defined by Grim as a term for the clay-sized mica-like minerals commonly found in argillaceous rocks. Illite is commonly interstratified by the smectite minerals. Vermicullite most commonly occurs as macroscopic crystals in solid temperate and subtropical climates. Many vermiculites form from the alteration of micas, clorites, and pyroxenes as result of hydrothermal alteration.

In addition, other minerals, aside from those described above, may appear in the brick additives. Such minerals include, but are not limited to amorphous opal CT, feldspars, kaolinite, mica and quartz.

To prepare these materials to be used a brick additives, they may be mined, crushed, dried, sized or granulated into granular particles. According to one embodiment, these crushed particles may then be superheated at temperatures ranging up to and including about 1200° C. (2192° F.), and typically with temperatures ranging between 300° C. (572° F.) and 900° C. (1652° F.). As used herein, the term superheated means heated to high temperatures, typically between about 900° C. and 1,200° C. without fusing or vitrifying. Applicants have found that it is helpful to superheat the phyllosilicates, but that it is an unnecessary process step to superheat diatomaceous earth and zeolites. Both diatomamaceous earth and zeolites may, however, undergo superheating without departing from the spirit of the present invention.

The actual superheating temperature depends upon the particular raw material used for the brick additive, and can be determined by one skilled in the art. If the superheating temperature and degree of thermal saturation for the particular precursor is too low, the granules may rehydrate upon the addition of water. Under these circumstances, the particles may undesirably flake or disaggregate into their fundamental minerals. Care should also be taken to avoid subjecting the particles to extremely high temperatures. If the temperature is too high, vitrification and desnification may occur and porosity/interconnectivity will be lost.

After superheating, individual particles of the brick additive typically comprise a substantially dust free granulate with particle sizes ranging from about 0.25 millimeters to about 5 millimeters in diameter. These values should be interpreted as producing a mesh size, based on the U.S. standard for measurement, between about 60 mesh and 3.5 mesh. Individual particle size and shape distribution may vary widely. Particles may show a morphology ranging from angular to spheroidal, including, but not limited to lenticulr (disk-shaped) or acicular (rod-shaped).

Once the colorant and brick additives have been prepared, the colorant may be applied to the brick additive, which in turn, is incorporated into a brick matrix before firing. Colorant addition to the brick additive can range up to about 90 wt. % andmore particularly within the range between about 0.1 wt. % to 15.0 wt. % and still more particularly between about 3.0 wt. % and 10.0 wt. %.

Application of the colorant to the brick additive can be achieved by either spraying or pouring the colorant solution/suspension onto the brick additive, while the brick additive is being tumbled and mixed. The additive can be tumbled/mixed by a rotatry drum, include pan agglomerator at an angle between about 10° and about 80°, pin mixer, paddle mixer, ribbon mixer, or some other mixing device. On application, the colorant typically penetrates the surface of the brick additive through the interconnected pores. To determine if the colorant has penetrated the interconnected pores, brick additive particles may be cut in half and visually inspected. If coloring of substantially all of the internal cross-section is present, penetration has occurred. Another possible method of applying the liquid colorant is to submerse the brick additive into the coloring solution/suspension and allow the colorant to be absorbed into the additive. Once the liquid colorant has been applied to the brick additive, mixing typically occurs from up to 15 minutes, more particularly between about 5.0 minutes and 10.0 minutes, so that the colorant has time to penetrate and absorb into interconnected pores of the additive.

An optional step following the application and mixing steps is to heat treat the colored treated additive from 850° F. (450° C.) up to 1,500° F. (815° C.). This step drives off any added liquids and helps produce a low volatile material.

After application of the colorant into the brick additive, a matrix material, such as clay, shale or some other earthy substance, may receive the brick additive. The colored additive is useful for both coated and uncoated bricks. Coated bricks typically comprise a dispersion called “engobe” sprayed on the face and end surfaces of the brick. Typically, engobe comprises a dispersion of a metal oxide, sodium bentonite and water; it is believed that make-up of engobe precludes penetration of the metal oxide component into substances comprising relatively small pores, such as phyllosilicate clay minerals. Depending on the nature of the brick matrix, brick additives of the present invention may be added in an amount of up to about 20% by volume, and typically in an amount of about 3.0 wt. % to about 15 wt. %.

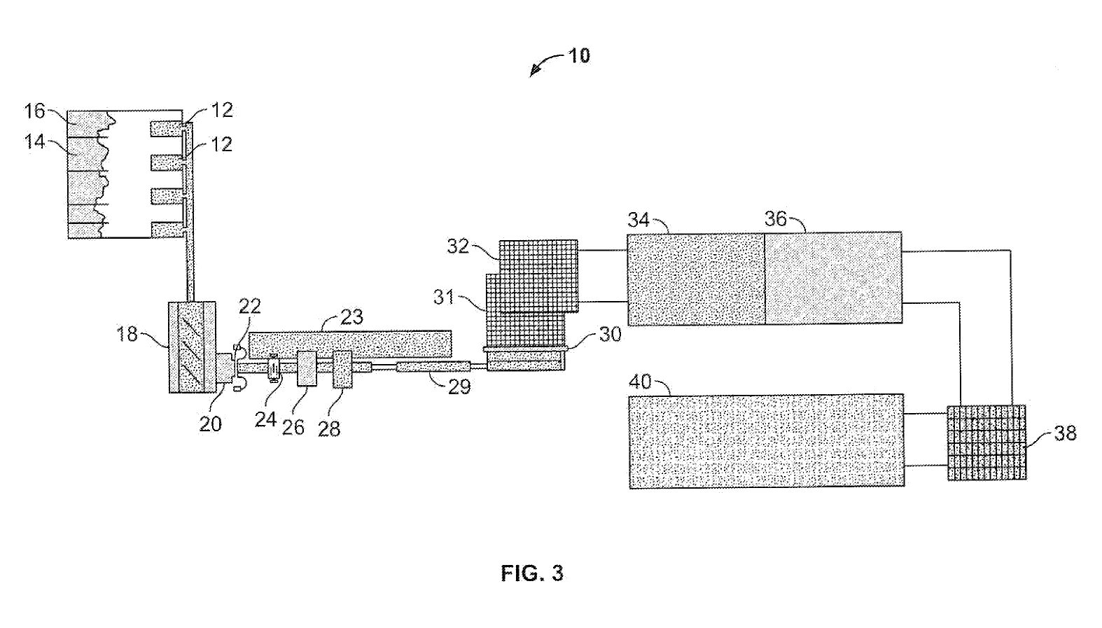

FIG. 3 is a schematic illustrating one embodiment of the brick making process with application of the colorant of the present invention to an additive added thereto. The system is designated generally by the reference character 10. Feeders 12 receive matrix material 14 and color-treated brick additive 16 for sending to pug mill 18. Pug mill 18 mixes matrix material 14 and brick additive 16 for extrusion by extruder 20. A cutting device 22 makes a velour cut on the extruded brick body, shaving off a surface of the face of the body, which is transferred to belt 24 for moving the brick bodies forward. Sand is typically added in chamber 26. In some cases, engobe is added with the sand in chamber 26. Typically, cutter 28 divides the brick bodies into slugs 29 for sending to a setting area, where wire cutter 30 further divides the brick bodies into cut wet bricks 31, often called “green bricks.” Setting machine 32 transfers the green bricks to kiln car 34, which in turn transfers them to holding room 36, typically set at a temperature of 90° F. From there, the green bricks move to dryers 38, where exposure to temperatures between about 250° F. and 500° F. occurs for about 24.0 hours. Firing kiln 40 between about 1,700° F. (926° C.) and about 2,500° F. (1,371° C.), and more particularly between 1,900° F. (1,037° C.) and 2,300° F. (1,230° C.) yields finished bricks.

Throughout this application, the term brick refers generally to any clay, shale or similar earthy substances that has been fired (such as common bricks, tile and pipes and pavers). Bricks may also comprise sand in various concentrations. The term clay refers to any material that is substantially pliable at appropriate water contents and less pliable when fired. Firing typically triggers a color change in the additive based on liberation of the volatile anion from the colorant at high temperatures.

The present invention is illustrated, but in no way limited by the following examples:

### EXAMPLES

In the Examples that follow, colorants were applied to brick additives comprising phyllosilicate clay granules, followed by incorporation of the brick additives into brick matrices to ascertain color differentials.

### Examples 1a)-c)

The Examples include: 1a) superheating phyllosilicate clay granules in the absence of the colorant of the present invention; 1b) treatment of phyllosilicate clay granules with various soluble cations followed by a 900° F. heat treatment; 1c) treatment of superheated phyllosilicate clay granules with soluble metal cations. The diameters of the clay granules were between about 0.60 mm and about 2.35 mm.

In each of Examples 1b) and 1c), iron (Fe) and manganese (Mn) containing salts were applied to clay granules due to their strong coloring properties. First, soluble iron and manganese salts were added to deionized water with dosages ranging from 1.0 wt. % up to 10.0 wt. % based on dry clay weight. The deionized water dosages ranged from 10.0 wt. % up to 35.0 wt. %, based on wet clay weight.

The sources and general properties for the metal salts utilized in the Examples were as follows:

| Metal Salt | Source | Properties |
|---|---|---|
| FeSO₄*7H₂O | QC Corporation | Green granules, ~8 wt. % |
| | | free moisture |
| Fe(C₂H₃O₂)₂ | Lab prepared from | Red/Brown precipitate dried |
| | acetic acid | to 0% free moisture |
| | digestion of | |
| | steel wool | |
| Fe(NO₃)₃*9H₂O | Fisher Scientific | Purple/TransIucent |
| | | granules, Dry |
| MnSO₄*1H₂O | Fisher Scientific | Pink powder, Dry |
| Mn(C₂H₃O₂)₂ | Sheperd Chemical | Pink powder, 2.9 wt. |
| | | % free moisture |
| KMnO₄ | Carus Company | Black crystals, Dry |
| | (Cairox ®) | |
| NaMnO₄ | Carus Company | Purple solution, 20 wt. % solids |
| | (Econox ®) | |

The quantities of each reactant were as follows:

| | | | | | Soluble Metal Salts | | | | | | |
|---|---|---|---|---|---|---|---|---|---|---|---|
| | | Clay | | Water | FeSO₄*7H₂O | Fe(C₂H₃O₂)₂ | Fe(NO₃)₃*9H₂O | MnSO₄*1H₂O | Mn(C₂H₃O₂)₂ | KMnO₄ | NaMnO₄ |
| | | Non-Superheated 1c) | Superheated 1b) | Deionized H₂O | QC Corp | Lab Prepared | Fisher Sci. | Fisher Sci. | Sheperd Chem. | Carus | Carus |
| Formulation | | grams | grams | grams | grams | grams | grams | grams | grams | grams | grams |
| Non-superheated Granules 1b) | | | | | | | | | | | |
| 1.0% FeSO₄ | 15.0% H₂O | 454.00 | | 67.73 | 4.59 | | | | | | |
| 2.0% FeSO₄ | 15.0% H₂O | 454.00 | | 58.83 | 9.27 | | | | | | |
| 3.0% FeSO₄ | 15.0% H₂O | 454.00 | | 66.98 | 14.04 | | | | | | |
| 4.0% FeSO₄ | 15.0% H₂O | 454.00 | | 66.58 | 18.92 | | | | | | |
| 5.0% FeSO₄ | 15.0% H₂O | 454.00 | | 66.19 | 23.89 | | | | | | |
| 5.0% FeSO₄ | 20.0% H₂O | 454.00 | | 89.39 | 23.39 | | | | | | |
| 5.0% FeSO₄ | 25.0% H₂O | 454.00 | | 112.09 | 23.39 | | | | | | |
| 5.0% FeSO₄ | 30.0% H₂O | 454.00 | | 134.79 | 23.39 | | | | | | |
| 5.0% FeSO₄ | 35.0% H₂O | 454.00 | | 157.49 | 23.39 | | | | | | |
| 0.5% Fe(C₂H₃O₂)₂ | 15.0% H₂O | 454.00 | | 68.10 | | 2.10 | | | | | |
| 0.92% Fe(C₂H₃O₂)₂ | 16.2% H₂O | 585.14 | | 95.00 | 5.00 | | | | | | |
| 1.0% Fe(C₂H₃O₂)₂ | 15.0% H₂O | 454.00 | | 68.10 | | 4.22 | | | | | |
| 1.5% Fe(C₂H₃O₂)₂ | 15.0% H₂O | 454.00 | | 68.10 | | 6.36 | | | | | |
| 5.2% Fe(C₂H₃O₂)₂ | 15.0% H₂O | 454.00 | | 68.10 | | 22.70 | | | | | |
| 6.1% Fe(C₂H₃O₂)₂ | 15.0% H₂O | 454.00 | | 68.10 | | 27.30 | | | | | |
| 1.0% Mn(C₂H₃O₂)₂ | 15.0% H₂O | 454.00 | | 66.38 | | | | 5.94 | | | |
| 2.0% Mn(C₂H₃O₂)₂ | 15.0% H₂O | 454.00 | | 64.63 | | | | 12.01 | | | |
| 3.0% Mn(C₂H₃O₂)₂ | 15.0% H₂O | 454.00 | | 62.83 | | | | 18.19 | | | |
| 4.0% Mn(C₂H₃O₂)₂ | 15.0% H₂O | 454.00 | | 60.99 | | | | 24.51 | | | |
| 5.0% Mn(C₂H₃O₂)₂ | 15.0% H₂O | 454.00 | | 59.12 | | | | 30.96 | | | |
| 1% KMnO₄ | 15.0% H₂O | 454.00 | | 68.10 | | | | | | 4.22 | |
| 2% KMnO₄ | 15.0% H₂O | 454.00 | | 68.10 | | | | | | 8.52 | |
| 3% KMnO₄ | 15.0% H₂O | 454.00 | | 68.10 | | | | | | 12.92 | |
| 1% NaMnO₄ | 15.0% H₂O | 454.00 | | 51.23 | | | | | | | 21.09 |
| 2% NaMnO₄ | 15.0% H₂O | 454.00 | | 34.00 | | | | | | | 42.62 |
| 3% NaMnO₄ | 15.0% H₂O | 454.00 | | 16.43 | | | | | | | 64.59 |

| Superheated granules 1c) | | | | | | |
|---|---|---|---|---|---|---|
| 1.1% FeSO₄ | 15.0% H₂O | 454.00 | 68.10 | 4.54 | | |
| 3.0% FeSO₄ | 15.0% H₂O | 454.00 | 66.88 | 15.25 | | |
| 4.0% FeSO₄ | 15.0% H₂O | 454.00 | 66.46 | 20.56 | | |
| 5.0% FeSO₄ | 15.0% H₂O | 454.00 | 66.02 | 25.97 | | |
| 5.0% FeSO₅ | 35.0% H₂O | 454.00 | 157.42 | 23.39 | | |
| 5.2% FeSO₄ | 15.0% H₂O | 454.00 | 68.10 | 22.70 | | |
| 9.8% FeSO₄ | 15.0% H₂O | 454.00 | 68.10 | 45.40 | | |
| 1.1% Fe(NO₃)₃ | 15.0% H₂O | 454.00 | 68.10 | | 4.54 | |
| 5.2% Fe(NO₃)₃ | 15.0% H₂O | 454.00 | 68.10 | | 22.70 | |
| 9.8% Fe(NO₃)₃ | 15.0% H₂O | 454.00 | 68.10 | | 45.40 | |
| 5.2% Fe(NO₃)₃ | 10.0% H₂O | 454.00 | 45.40 | | 22.70 | |
| 9.8% Fe(NO₃)₃ | 10.0% H₂O | 454.00 | 45.40 | | 45.40 | |
| 6.9% FeSO₄/2.9% MnSO₄ | 15.0% H₂O | 454.00 | 68.10 | 31.78 | | 13.62 |
| 4.9% FeSO₄/4.9% MnSO₄ | 15.0% H₂O | 454.00 | 68.10 | 22.70 | | 22.70 |
| 2.9% FeSO₄/6.9% MnSO₄ | 15.0% H₂O | 454.00 | 68.10 | 13.92 | | 31.78 |
| 1.1% MnSO₄ | 15.0% H₂O | 454.00 | 68.10 | | | 4.54 |
| 5.2% MnSO₄ | 15.0% H₂O | 454.00 | 68.10 | | | 22.70 |
| 9.8% MnSO₄ | 15.0% H₂O | 454.00 | 68.10 | | | 45.40 |

The metal salt solutions were sprayed onto the porosity clay material in a small inclined pan agglometer operating at 30 rpm, inclined at an angle of about 45°. The spray application was carried out by a gravity fed spray gun operating at 20 psi. After the application of the metal salt solution, the granules were tumbled in the pan agglomerator for 5 minutes to allow ample time for the granules to absorb the metal salt solution. The treated granules of Example 1b) were then heated to 900° F., while the treated granules of Example 1c) were used as is.

### Examples 2a) and 2b)

After colorant application, each batch of granules from Examples 1a)-1c) was divided in unconsolidated granules and granules incorporated into a brick matrix material for making brick cookies. Both the inconsilidated granules and the brick cookies comprising the granules were heated under brick firing conditions (˜2,100° F. and oxidizing amopsher). Heat treatments and brick firings were carried out using a Lindberg/Blue M static electric laboratory furnace. The brick cookies were used to determine if the treated granules were distinguishable in the fired brick mix. Cookies were prepared by first blending 6.61 wt. % of the granules into a “red-body” brick mix. The blended cookie mixture was then pressed to 2.25 inch diameter cookies at 22,000 to 23,000 psi and then fired to 2,100° F. Following the firing stage, the unconsolidated granules and pressed cookies were visually inspected to determine the effectiveness of the metal salt dosage.

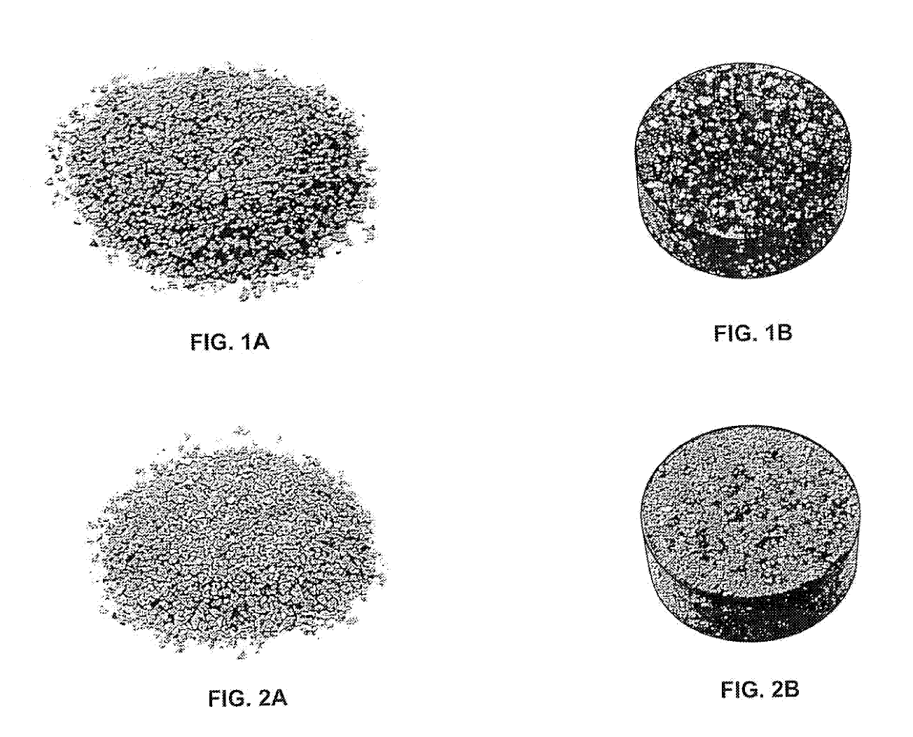

In Example 2a, the untreated granules of Example 1a, when fired to 2,100° F., yield bright tan to orange granules which were highly distinguisable in the final fired brick. Images of these unconsolidated granule and the wire incorporation into the brick cookie are shown in FIGS. 1A and 1B.

In Example 2b, the color treated granules of Examples 1b and 1c were observed in unconsolidated form and after incorporation into a brick cookie. As shown in FIGS. 2A and 2B, the granules of Examples 1b and 1c blended with the brick cookie as were virtually indistinguishable in color from the brick cookie matrix. The color intensity of the metal salts is fairly equivalent in both the non-superheated granules of Example 1b) and the superheated granules of Example 1c).

The iron based salts provide a dark red-orange color to the granules upon firing at 2,100° F. Based on an equal dosage, the iron acetate (Fe(C₂H₃O₂)₂) provides the darkest color change followed by the iron surface (FeSO₄*7H₂O) and iron nitrate (Fe(NO₃)₃*9H₂O). The difference in color intensity is believed to be due to the iron salt. The iron acetate has a total concentration of 32.1%, where as the iron sulfate and iron nitrate have 20.1% and 13.8% total iron, respectively.

The manganese based salts turn the granules to a light to medium brown color upon heating to 2,100= F. The K/Na-permanganate salts (KMnO₄ & NaMnO₄) contribute more Mn than the manganese sulfate (MnSO₄*1H₂O) and manganese acetate (Mn(C₂H₃O₂)₂) due to a higher Mn concentration in the starting salts. The K/Na-permanganate salts have 34.8% to 38.7% total manganese, where as manganese sulfate and acetate have 32.5% and 31.8% total manganese, respectively. Therefore less K/Na-permanganate is needed to obtain equal coloring power as is needed from manganese acetate.

It was observed that increasing the amount of water used in the salt solution increases the distribution of the metal salts throughout the brick additive by providing a more extensive and uniform degree of fluid saturation. The better distribution provides a more uniform and even colored on the granules. Water addition can be added up to 50 wt. % of the brick additive.

Variations, modifications and other implementations of what is described herein will occur to those of ordinary skill in the art without departing from the spirit and scope of the invention. Accordingly, the invention is in no way limited by the preceding illustrative description.

What is claimed is:

1. A process for making finishes bricks comprising:
providing a matrix material for forming the finished bricks,
providing a brick additive or incorporation into the matrix material, the brick additive comprising a plurality of particles with a plurality of interconnected pores;
combing a colorant with a liquid to form a liquid-based colorant;
applying the liquid-based colorant to the brick additive, such that at least a portion of the liquid-based colorant penetrates the interconnected pores of the plurality of particles,
incorporating the brick additive into the matrix material; and
firing the matrix material into the finished bricks.

2. The process of claim 1, wherein the liquid-based colorant comprises a metal cation.

3. The process of claim 1, wherein the colorant is selected from the group consisting of metal salts, including iron sulfate, iron nitrate, manganese sulfate, potassium permanganate, iron acetate, iron stearates, manganese acetate, metal oxides, including iron oxide, manganase oxide, pure metals, including iron, manganese, nanoparticles comprising metal cations, organometalic compounds, and combinations thereof.

4. The process of claim 1, wherein the brick additive comprising the colorant exhibits substantially the same color as the matrix material in the finished bricks after the firing step.

5. The process of claim 1, wherein the colorant is capable of withstanding temperatures up to about 1,350° C. without a substantial loss of color imparting properties.

6. The process of claim 1, wherein the applying step comprises spraying the liquid based colorant onto the plurality of particles.

7. The process of claim 1, wherein the brick additive comprises at least one of a zeolite and diatomaceous earth and the liquid is water.

8. The process of claim 1, further comprising at least one of mixing and tumbling the brick additive during the applying step.

9. The process of claim 1, further comprising heating the brick additive after the applying step but before the firing step at temperatures between about 454° C. and 815° C.

10. The process of claim 1, wherein the colorant is added to the brick additive in an amount between about 0.1 wt. % and 15.0 wt. %.

11. A process for making finished bricks comprising:
providing a matrix material for forming the finished bricks,
providing a brick additive for incorporation into the matrix material, the brick additive comprising a phyllosilicate clay mineral;
combining a colorant with a liquid to form a liquid-based colorant;
applying the liquid-based colorant to the brick additive;
incorporating the brick additive into the matrix material; and
firing the matrix material into the finished bricks, wherein the brick additive comprising the liquid-based colorant exhibits substantially the same color as the matrix material in the finished bricks after the firing step.

12. The process of claim 11, wherein the liquid-based colorant comprises a metal cation.

13. The process of claim 11, wherein the colorant is selected from the group consisting of metal salts, including iron sulfate, iron nitrate, manganese sulfate, potassium permanganate, iron acetate, iron stearates, manganese acetate, metal oxides, including iron oxide, manganese oxide, pure metals, including iron, manganese, nanoparticles comprising metal cations, organometalic compounds, and combinations thereof.

14. The process of claim 11, wherein the colorant comprises a diameter less than about 750.0 nanometers.

15. The process of claim 11, wherein the colorant is capable of withstanding temperatures up to about 1,350° C. without a substantial loss of color imparting properties.

16. The process of claim 11, wherein the applying step comprises spraying the liquid based colorant onto the plurality of particles.

17. The process of claim 11, wherein the liquid is water.

18. The process of claim 11, further comprising at least one of mixing and tumbling the brick additive during the applying step.

19. The process of claim 11, further comprising heating the brick additive after the applying step but before the firing step at temperatures between about 454° C. and 815° C.

20. The process of claim 11, wherein the colorant is added to the brick additive in an amount between about 0.1 wt. % and 15.0 wt. %.
